(19) United States
(12) Patent Application Publication
(10) Pub. No.: US 2005/0058050 A1
(43) Pub. Date: Mar. 17, 2005

(54) Optical pick-up having a spherical aberration compensator and a method of compensating for spherical aberration

(76) Inventors: Soo-han Park, Yongin-si (KR); Bong-gi Kim, Suwon-si (KR); Tae-youn Heor, Suwon-si (KR); Seong-su Park, Suwon-si (KR); Jung-woo Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/918,376

(22) Filed: Aug. 16, 2004

(30) Foreign Application Priority Data
Sep. 15, 2003 (KR) 2003-63844
Nov. 4, 2003 (KR) 2003-77537

(51) Int. Cl. G11B 7/00

(52) U.S. Cl. 369/112.02; 369/112.16

(57) ABSTRACT

An optical pick-up apparatus and method incorporating a spherical aberration compensator is disclosed. The optical pick-up employs the spherical aberration device that comprises a wave plate for converting the phase of beams entering the wave plate and outputting the phase-converted beams; and a liquid crystal panel having a molecular structure for adjusting the phase of circularly-polarized beams, whereby it is possible to compensate for the spherical aberrations of the laser beams emitted from a light source and entering an optical recording medium, and the laser beams which are reflected from the optical recording medium and reenter the liquid crystal panel. As a result, jitter characteristic of the optical pick-up can be enhanced.

### CROSS-REFERENCE TO RELATED APPLICATIONS

This application claims the benefit under 35 U.S.C. § 119 (a) of Korean Patent Application Nos. 2003-63844 and 2003-77537, filed on Sep. 15, 2003 and Nov. 4, 2003, in the Korean Intellectual Property Office, the entire contents of which are incorporated herein by reference.

### BACKGROUND OF THE INVENTION

1. Field of the Invention

The present invention relates to an optical pick-up for a blue-ray disc and a method thereof. In particular, the present invention relates to an optical pick-up apparatus and method for compensating for spherical aberrations produced in the process of emitting laser beams from a light source onto an optical recording medium and wherein the laser beams are reflected by an optical disc.

2. Description of the Related Art

As optical discs employing laser diodes have become popular, research for ways of increasing the recording capacities of optical discs is being conducted. Blue-ray discs are optical recording mediums onto which a large amount of data can be recorded. The blue-ray discs have a track pitch which is about half of that of existing compact discs (CDs), or about 0.32 μm. As a result, it is possible to record or reproduce a maximum of 27 GB data onto or from one side of a 12 cm blue-ray disc. In order to increase the capacity, blue-ray discs employ a disc structure having a 405 nm bluish-purple semiconductor laser (BPSL), an object lens having a numerical aperture (NA) of 0.85, and a light-permeable protective layer having a thickness of 0.1 mm.

An optical pick-up for such a blue-ray disc comprises a light source for illuminating a 405 nm BPSL, a half-wave plate for converting laser beams emitted from the light source into parallel beams, a beam splitter for reflecting and transmitting the parallel beams received from the half-wave plate in a predetermined ratio, a collimator lens for converting the laser beams received from the beam splitter into parallel beams, a reflex mirror for reflecting the laser beams emitted through the collimator lens in a predetermined angle, a quarter-wave plate for rotating received polarized beams of the laser beams received from the reflex mirror to a predetermined direction, an object lens for focusing the laser beams received through the quarter-wave plate onto an optical disc, a sensor lens for collecting the laser beams reflected from the optical disc and incident through the object lens, reflex mirror, collimator lens, and beam splitter, and a photo detector for converting the laser beams received from the sensor lens into electric signals.

The optical pick-up as described operates as follows: laser beams emitted from the light source are received onto the optical disc through the half-wave plate, beam splitter, collimator lens, reflex mirror, quarter-wave plate and object lens. Consequently, a beam spot is formed on a recording layer of the optical disc. In addition, the laser beams received onto the optical disc are reflected by the optical disc and enter the photo detector through the object lens, reflex mirror, collimator lens, beam splitter and sensor lens.

In the process of emitting the laser beams from the light source onto the optical disc, the laser beams are reflected by the optical disc and produce spherical aberrations. For example, if laser beams are emitted from the light source onto the optical disc through one or more optical components located on the optical path, a spherical aberration is produced due to a difference of refractive indexes. In addition, when the laser beams received by the optical disc are reflected by the optical disc, a spherical aberration is produced based on a deviation in thickness of a protective layer of the optical disc. In particular, since the spherical aberration produced due to the deviation in thickness of the protective layer of the optical disc is proportional to the cube of NA (numerical aperture) of the object lens, the spherical aberration is largely affected by the deviation in thickness of the protective layer as the NA of the object lens increases.

Therefore, a spherical aberration compensator is required for compensating for the spherical aberrations produced in the laser beam emitting and reflecting process. If laser beams are received by an optical disc without compensating for the spherical aberrations as mentioned above, a beam spot formed on the recording layer of the optical disc deviates from a focusing position and a tracking position, whereby the recording capability of an optical pick-up deteriorates. In particular, if the laser beams are received by a photo detector without compensating for the spherical aberration produced due to a deviation in thickness of the protective layer, it is difficult to precisely trace tracks due to interference between adjacent signals. This may cause information to be recorded on an incorrect track or data already recorded on neighbor tracks to be erased due to it being overwritten. As a result, the jitter compensating characteristic of the optical pick-up device deteriorates.

### SUMMARY OF THE INVENTION

Accordingly, the present invention has been developed to solve the above-mentioned problems occurring in the related art. An aspect of the present invention is to provide an optical pick-up apparatus adapted to compensate for spherical aberrations produced in the process of emitting laser beams from a light source onto an optical recording medium that and reflecting the laser beams are reflected from the optical recording medium.

In order to achieve the above aspect, there is provided a spherical aberration compensator comprising a wave plate for converting a phase of received beams by rotating the beams about 90°; and a liquid crystal panel having an arrangement of liquid crystal molecules capable of adjusting a phase of circularly-polarized beams.

The liquid crystal panel preferably comprises a plurality of transparent substrates opposing each other; a plurality of transparent electrodes provided on inner sides of the substrates, respectively, electric power being applied to the transparent electrodes; and a liquid crystal layer formed from liquid crystal molecules aligned in a predetermined direction and angle in relation to the surfaces of the transparent electrodes, the liquid crystal layer transmitting incident beams in different refractive indexes depending on polarized directions of the incident beams. It is preferred that the liquid crystal molecules are tilted 45° toward a predetermined direction so as to facilitate the adjusting of a phase of incident circularly-polarized beams.

The liquid crystal panel according to an embodiment of the present invention compensates for a spherical aberration by adjusting the refractive index of the liquid crystal layer in such a manner that an inverse aberration is produced which corresponds to a spherical aberration of incident laser beams depending on whether electric power is applied to the liquid crystal panel or not.

In addition, an aspect of the present invention provides a spherical aberration compensator. The spherical aberration compensator comprises a liquid crystal panel having an arrangement of liquid crystal molecules capable of adjusting a phase of parallel beams polarized vertically or horizontally to and incident into an incident surface, and a wave plate for converting a phase of incident beams by rotating the incident beams about 180°.

The liquid crystal panel in this case comprises a plurality of transparent substrates opposing each other; a plurality of transparent electrodes provided on inner sides of the substrates, respectively, electric power being applied to the transparent electrodes; and a liquid crystal layer formed from liquid crystal molecules aligned in one of horizontal and vertical directions in relation to the surfaces of the transparent electrodes. The liquid crystal layer transmits incident beams in different refractive indexes depending on the polarized directions of the incident beams. By compensating for spherical aberrations of laser beams received by an optical recording medium and laser beams reflected by the optical recording medium and then entering a photo detector using the spherical aberration compensator as described above, it is possible to enhance recording and reproducing capabilities of the optical pick-up.

In order to achieve the above object, there is also provided a spherical aberration compensator which comprises a liquid crystal panel having an arrangement of liquid crystal molecules capable of compensating a spherical aberration for S-polarized beams; a first wave plate for converting incident laser beams into S-polarized beams if and when the laser beams are emitted from a light source and received by the optical recording medium through the liquid crystal panel; and a second wave plate for converting laser beams reentering the liquid crystal panel into S-polarized beams when the laser beams reflected from the optical medium reenter the photo detector through the liquid crystal panel.

In addition, an aspect of the present invention provides a spherical aberration compensator capable of compensating for a spherical aberration of P-polarized beams. The spherical aberration compensator comprises a liquid crystal panel having an arrangement of liquid crystal molecules capable of compensating for a spherical aberration for P-polarized beams; first and second wave plates for converting laser beams reflected from an optical recording medium and reentering a photo detector into P-polarized beams, thus transmitting the P-polarized beams. The first wave plate is a half-wave plate for rotating the beams about 180° for a phase of received beams to convert the phase and the second wave plate is a quarter-wave plate for rotating the phase of incident beams about 90° to convert the phase.

### BRIEF DESCRIPTION OF THE DRAWINGS

The above and other objects, features and advantages of the present invention will be more apparent from the following detailed description taken with reference to the accompanying drawings, in which:

FIG. 1 is a schematic view showing a construction of an optical pick-up including a spherical aberration compensator according to an embodiment of the present invention;

FIG. 2 is a view showing in detail the construction of a liquid crystal panel shown in FIG. 1;

FIG. 3 is a view illustrating the operation of the spherical aberration compensator shown in FIG. 1;

FIGS. 4A and 4B are graphs illustrating the compensating principle of the spherical aberration compensator shown in FIG. 1;

FIG. 5 is a schematic view showing a construction of an optical pick-up apparatus including a spherical aberration compensator according to another embodiment of the present invention;

FIG. 6 is a view illustrating the operation of the spherical aberration compensator shown in FIG. 5;

FIG. 7 is a schematic view showing a construction of an optical pick-up apparatus including a spherical aberration compensator according to another embodiment of the present invention;

FIG. 8 is a view illustrating the operation of the spherical aberration compensator shown in FIG. 7;

FIG. 9 is a schematic view showing a construction of an optical pick-up apparatus including a spherical aberration compensator according to another embodiment of the present invention; and

FIG. 10 is a view illustrating the operation of the spherical aberration compensator shown in FIG. 9.

In the following description, it should be understood that like reference numerals are used for the same elements throughout the drawings.

### DETAILED DESCRIPTION OF THE EXEMPLARY EMBODIMENTS

Hereinbelow, embodiments of the present invention will be described in detail with reference to the accompanying drawings.

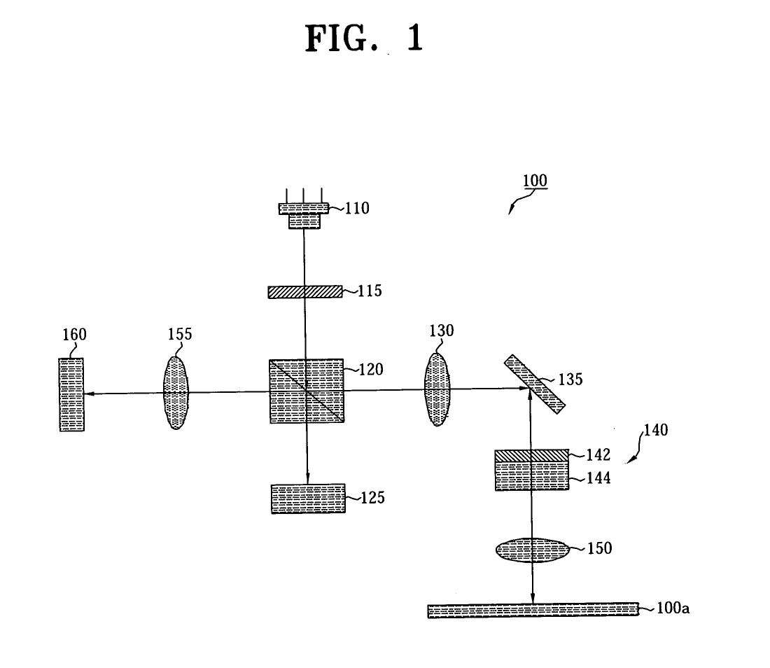

FIG. 1 is a view showing a construction of an optical pick-up apparatus including a spherical aberration compensator according to an embodiment of the present invention. Hereinbelow, description will be made as to an optical pick-up apparatus for a blue-ray disc capable of recording or reproducing data into or from an optical recording medium by illuminating predetermined laser beams onto the optical recording medium, by way of an example.

An optical pick-up apparatus 100 comprises a blue laser diode 110, a half-wave plate 115, a beam splitter 120, a front monitor photo-diode (FPD) 125, a collimator lens 130, a reflex mirror 135, a spherical aberration compensator 140, an object lens 150, a sensor lens 155, and a photo detector 160.

The blue laser diode 110 (hereinbelow, to be referred to as “Blue-LD”) is a light source for emitting bluish-purple semiconductor laser beams with a wavelength of 408 nm. The laser beams emitted from the Blue-LD 110 may have characteristics of being P-polarized beams polarized in the horizontal direction with respect to an incident surface, S-polarized beams polarized in the vertical direction with respect to the incident surface, right-circularly-polarized beams, and left-circularly-polarized beams.

The half-wave plate 115 converts a direction of received polarized light by rendering a phase of laser beams received from the Blue-LD 110 to be preceded or delayed about 180°. That is, the half-wave plate 115 converts laser beams into P-polarized beams or S-polarized beams and then transmits them.

The beam splitter 120 reflects and transmits the laser beams received through the half-wave plate 115 in a predetermined ratio. Accordingly, a portion of the laser beams received from the half-wave plate 115 will be transmitted onto the FPD 125 as will be described later, and the remainder of the laser beams will be reflected by the beam splitter 120 and then enter the collimator lens 130.

The FPD 125 detects the quantity of light of the laser beams received from the beam splitter 120 and adjusts the quantity of light illuminated from the Blue-LD 110. The laser beams received by the FPD 125 is converted into electrical signals and used in providing automatic power control.

The collimator lens 130 converts the laser beams receiving a radiation angle from the beam splitter 120 into parallel beams and then transmits them.

The reflex mirror 135 reflects the laser beams emitted from the collimator lens 130 in such a manner that the laser beams emitted from the collimator lens 130 enter the object lens 150.

The spherical aberration compensator 140 is located between the reflex mirror 135 and the object lens 150 and compensates for the spherical aberrations of the laser beams received from the reflex mirror 135 and the laser beams reflected from the optical disc 100a.

The spherical aberration compensator 140 has a quarter-wave plate 142 and a liquid crystal panel 144.

The quarter-wave plate 142 converts parallel laser beams, which are vertically or horizontally polarized in relation to the direction of the laser beams and into left-circularly-polarized beams or right-circularly-polarized beams by rotating the phase of the polarized and incident laser beams about 90° or converts the circularly-polarized beams received from the liquid crystal panel 144 into parallel beams by rotating the phases of the circularly-polarized beams about 90°, and then emits the converted beams. That is, the quarter-wave plate 142 converts the P-polarized beams received from the reflex mirror 135 into right-circularly-polarized beams and allows the right-circularly-polarized beams to enter the liquid crystal panel 144. The quarter-wave plate converts the left-circularly-polarized beams reflected by the optical disc 100a to reenter the quarter-wave plate 142 and convert into S-polarized beams and emit the S-polarized beams to the reflex mirror 135.

The liquid crystal panel 144 compensates the spherical aberrations of the laser beams by adjusting the phases of the laser beams emitted from the quarter-wave plate 144 and received by the optical disc 100a through the object lens 150, and the laser beams reflected and received from the optical disc 100a.

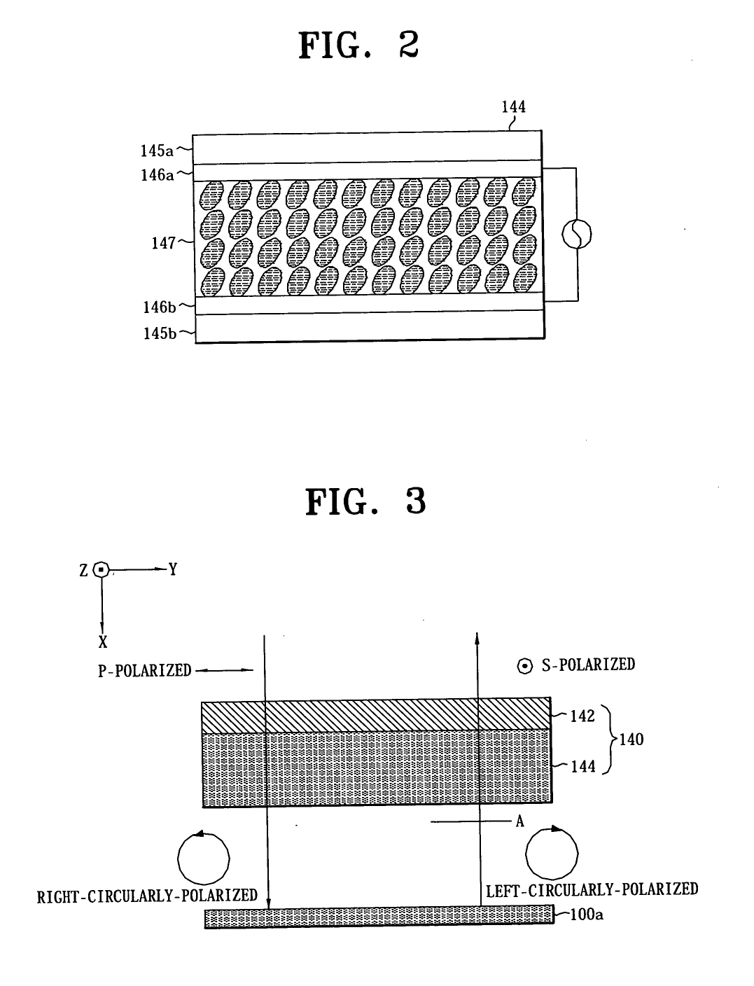

As shown in FIG. 2, the liquid crystal panel 144 comprises a plurality of transparent substrates 145a, 145b opposing each other; a plurality of transparent electrodes 146a, 146b formed on inner sides of the transparent substrates 145a, 145b, respectively, electric power being applied to the transparent electrodes 146a, 146b; and a liquid crystal layer 147 formed between the transparent electrodes 146a, 146b. The liquid crystal layer transmits received laser beams in different refractive indexes depending on polarized directions of the laser beams when electric voltage is applied to the transparent electrodes 146a, 146b.

In order to compensate for the spherical aberrations of the laser beams received from the quarter-wave plate 142 and the laser beams reflected from the optical disc 100a, the liquid crystal molecules formed in the liquid crystal layer 147 are aligned in such a manner that the direction of main axes thereof tilts to a predetermined angle (e.g., 45°) in relation to the transparent substrates 145a, 145b. Accordingly, the refractive indexes of incident laser beams can be easily controlled. However, embodiments of the present invention are not necessarily limited to this predetermined angle.

The liquid crystal molecules aligned in the liquid crystal layer 147 are rotated to a predetermined direction by electric voltage applied to the transparent electrodes 146a, 146b, in which the liquid crystal panel 144 adjusts the refractive indexes of the liquid crystal layer 147 in such a manner that a phase of received laser beams is converted in response to the alignment of liquid crystal molecules, which is changed by the applied electric voltage. Specifically, the liquid crystal panel 144 adjusts the refractive index of the liquid crystal layer 147 in such a manner that an inverse spherical aberration distribution is produced which corresponds to a spherical aberration distribution of laser beams entering the liquid crystal layer 147.

The object lens 150 focuses laser beams subjected to spherical aberration compensation by the liquid crystal panel 144 onto a recording layer of the optical disc 100a. Accordingly, a beam spot is formed on the recording layer of the optical disc 100a.

The sensor lens 155 is a type of concave lens and collects laser beams, which are reflected from the optical disc 100a and received through the object lens 150, the spherical aberration compensator 140, the reflex mirror 135, the collimator lens 130 and the beam splitter 120, in a circular shape or an oval shape depending on a focusing state.

The photo detector 160 is a type of photo-diode, and coverts a beam spot, which is received having a circular or oval shape from the sensor lens 155, into electrical signals. The detection operation of the photo detector 160 is well known in the art and a detailed description thereof is omitted.

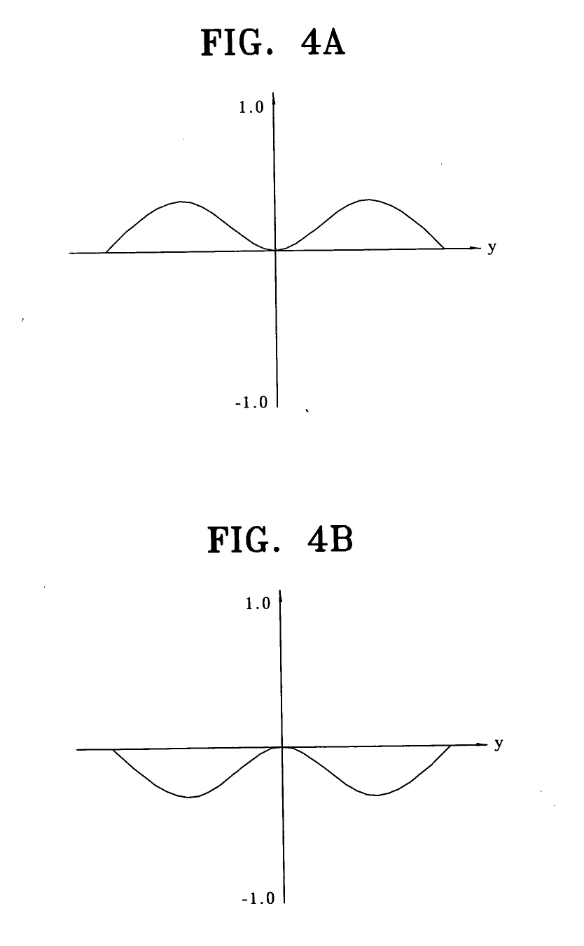

The control operation of the optical pick-up apparatus capable of executing spherical aberration compensation will now be described with reference to FIGS. 3 and 4. The case in which laser beams emitted from a Blue-LD 110 are converted into P-polarized beams by the half-wave plate 115 and then outputted will now be described.

At first, laser beams with a predetermined wavelength (e.g., 405 nm), which are emitted from the Blue-LD 110, are converted into P-polarized beams by the half-wave plate 115. The converted P-polarized beams are incident into the beam splitter 120, and then reflected and transmitted in a predetermined ratio by the splitter 120. A portion of the light of the P-polarized beams received by the beam splitter 120 is transmitted and enters the front monitor photo-diode 125 and the remainder is reflected and enters the collimator lens 130.

The collimator lens 130 converts P-polarized beams having a predetermined radiation angle via the beam splitter 120 into parallel beams and then transmits the parallel beams. The P-polarized beams received from the collimator lens 130 are reflected about 90° by the reflex mirror 135 and then enter the spherical aberration compensator 140.

FIG. 3 is a view illustrating the operation of the spherical aberration compensator shown in FIG. 1.

In FIG. 3, the X-axis refers to the direction of the laser beams, the Y-axis refers to the direction horizontal to the direction of travel of the laser beams, and the Z-axis refers to the direction vertical to the direction of travel of the laser beams. Therefore, P-polarized beams refer to beams polarized in the Y-axis direction, and S-polarized beams refer to beams polarized in the Z-axis direction.

Referring to FIG. 3, the phase of P-polarized beams entering the spherical aberration compensator 140 are preceded about 90° by the quarter-wave plate 142 and thus converted into right-circularly-polarized beams. The beams converted into right-circularly-polarized beams by the quarter-wave plate are subjected to spherical aberration compensation by the liquid crystal panel 144. That is, the liquid crystal panel 144 adjusts the refractive index of the liquid crystal layer 147 in such a manner that an inverse spherical aberration distribution is produced, which corresponds to a spherical aberration distribution of the right-circularly-polarized beams received by the optical disc 100a. Accordingly, the right-circularly-polarized beams received by the liquid crystal panel 144 are subjected to spherical aberration compensation by the liquid crystal panel 144 and then enter the object lens 150. The right-circularly-polarized beams subjected to spherical aberration compensation by the liquid crystal panel 144 are collected by the object lens 150 and then received by the optical disc 100a. Thereby, a beam spot is formed on the recording surface of the optical disc 100a.

The beam spot formed on the recording layer of the optical disc 100a is reflected by a pit formed on the optical disc 100a and then enters the photo detector 160 through the object lens 150, the spherical aberration compensator 140, the reflex mirror 135, the collimator lens 130, the beam splitter 120, and the sensor lens 155. The laser beams reflected from the optical disc 100a are changed due to the difference of thickness in the protective layer of the optical disc 100a, whereby a spherical aberration is produced. The liquid crystal panel 144 compensates for the spherical aberration produced due to the difference in thickness in the protective layer of the optical disc 100a.

FIGS. 4A and 4B are graphs for illustrating the method of compensating the spherical aberration of the laser beams entering the “A” section in FIG. 3.

Referring to FIGS. 4A and 4B, if left-circularly-polarized beams reflected from the optical disc 100a and reentering the “A” section have a spherical aberration as shown in FIG. 4A due to the thickness of the optical disc 100a, refractive index of a medium, numerical aperture of an object lens, or the like, the liquid crystal panel 144 adjusts the refractive index of the liquid crystal layer 147 in such a manner that an inverse spherical aberration is produced as shown in FIG. 4B. That is, the spherical aberration of the left-circularly-polarized beams received by the liquid crystal panel 144 is attenuated by the inverse spherical aberration produced by the liquid crystal panel 144, thereby being compensated.

In addition, the left-circularly-polarized beams subjected to spherical aberration compensation through the liquid crystal panel 144 are received by the quarter-wave plate 142. The left-circularly-polarized beams received by the quarter-wave plate 142 are transmitted after being converted into S-polarized beams as the phase thereof is delayed about 90° through the quarter-wave plate 142. The S-polarized beams received from the quarter-wave plate 142 are reflected about 90° by the reflex mirror 135 and then enter the collimator lens 130.

The S-polarized beams received from the reflex mirror 135 are converted into parallel beams by the collimator lens 130 and then enter the beam splitter 120. The S-polarized beams entering the beam splitter 120 are received and collected by the sensor lens 155 and then enter the photo detector 160. The S-polarized beams received by the photo detector 160 are collected in a segmented sensor and divided into a predetermined number of areas (e.g., 8-segmented sensor or 12-segmented sensor). The detection operation of the photo detector 160 is well known in the art, and a detailed description thereof is omitted.

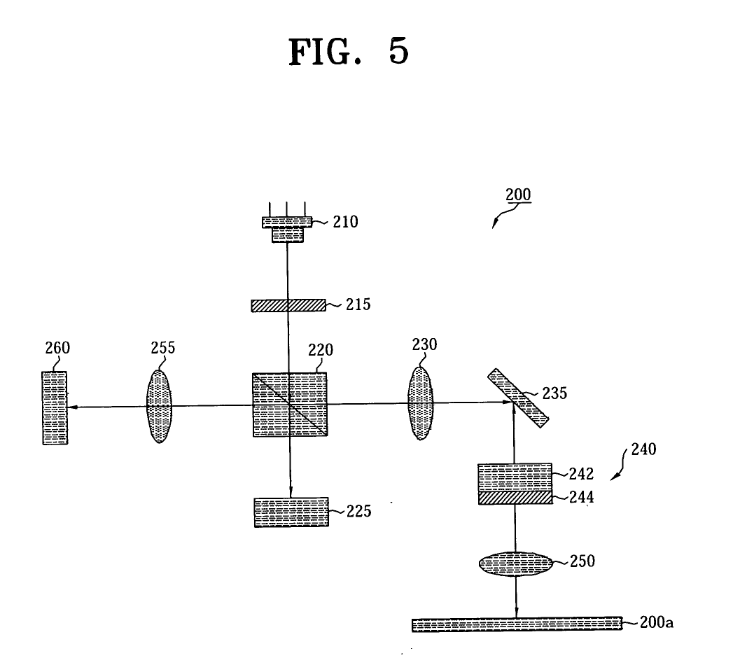

Meanwhile, FIG. 5 is a view showing a construction of an optical pick-up apparatus including a spherical aberration compensator according to another embodiment of the present invention. The optical pick-up apparatus 200 according to an embodiment of the present invention employs a spherical aberration compensator having a construction different from that of the spherical aberration compensator 140 employed in the optical pick-up apparatus 100 according to the first embodiment of the present invention. Hereinbelow, only the parts related to the spherical aberration device 240 according to an embodiment of the present invention are described while the detailed description for remaining optical components is omitted because they are similar or substantially similar to optical pick-up apparatus 100.

The spherical aberration compensator 240 according to an embodiment of the present invention comprises a liquid crystal panel 242 and a half-wave plate 244.

The liquid crystal panel 242 adjusts a phase of the laser beams which are received by the liquid crystal panel 242 through a reflex mirror 235, and laser beams which are reflected from an optical disc 200a and reenter the liquid crystal 242, thereby compensating for spherical aberrations.

The liquid crystal panel 242 comprises a plurality of transparent substrates opposing each other; a plurality of transparent electrodes formed on inner sides of the transparent substrates, respectively, electric power is applied to the transparent electrodes; and a liquid crystal layer formed between the transparent electrodes and transmitting laser beams having different refractive indexes depending on polarized directions of the laser beams when electric voltage is applied to the transparent electrodes. The liquid crystal molecules formed in the liquid crystal layer are aligned horizontally or vertically to the surfaces of the transparent substrates. This is because the liquid crystal panel 242 according to an embodiment of the present embodiment is implemented to provide spherical aberration compensation as to P-polarized beams.

The half-wave plate 244 changes the direction of incident polarized beams, which are received from the liquid crystal panel 242 by rotating the phase of laser beams about 180°. In addition, the half-wave plate 244 changes the direction of received polarized beams reflected and reentering the half-wave plate 244 from the optical disc 200a by rotating the beams about 180°.

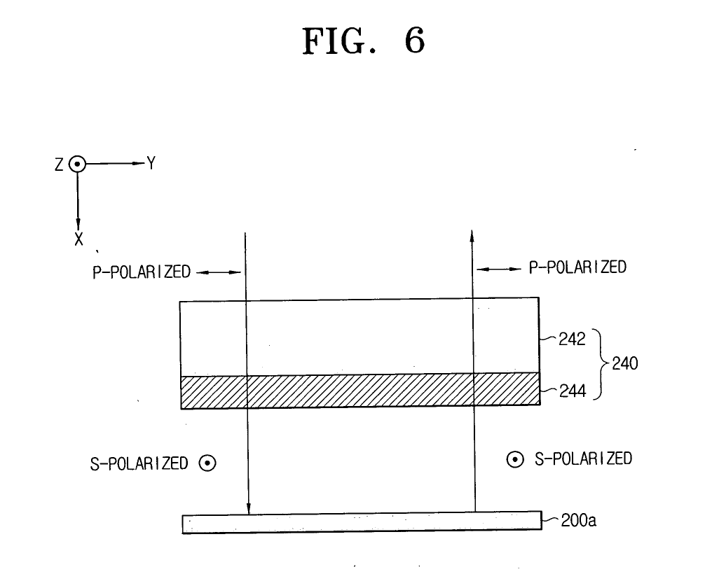

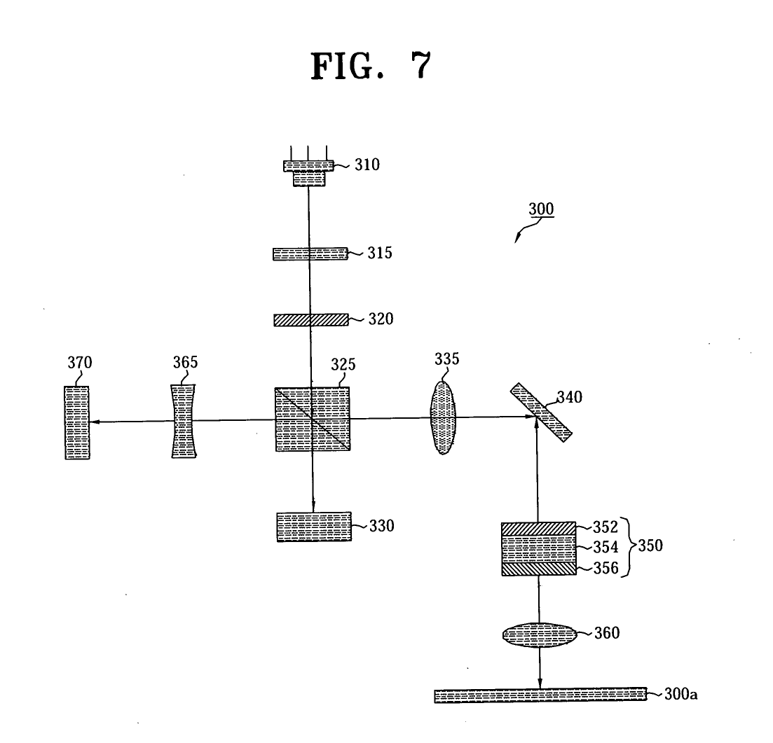

FIG. 6 is a view for illustrating the operation of the spherical aberration compensator shown in FIG. 5.

Referring to FIG. 6, P-polarized beams, (beams polarized in the Y-axis direction) are received and then transmitted through the liquid crystal panel 242 after the spherical aberration thereof is compensated. That is, the liquid crystal panel 242 adjusts the refractive index of the liquid crystal layer in such a manner that an inverse spherical aberration is produced, which corresponds to a spherical aberration of the P-polarized beams. Accordingly, the P-polarized beams received by the liquid crystal panel 242 are subjected to spherical aberration compensation and then enter the half-wave plate 244. The P-polarized beams entering the half-wave plate 244 are converted into S-polarized beams by the half-wave plate 244.

The S-polarized beams emitted from the half-wave plate 244 are received and collected by the object lens 250 and then received by the optical disc 200a. Thereby, a beam spot is formed on the recording layer of the optical disc 200a. The S-polarized beams received by the optical disc 200a are reflected by the optical disc 200a and then reenter the half-wave plate 244. The S-polarized beams reflected and received from the optical disc 200a are converted into P-polarized beams by the half-wave plate 244, and then enter the liquid crystal panel 240. The liquid crystal panel 240 transmits the P-polarized beams received through the half-wave plate 244 after compensating for the spherical aberration of the P-polarized beams. The spherical aberration compensating principle of the liquid crystal panel 242 according to the present embodiment is identical to that of the liquid crystal panel 144 according to the first embodiment, and thus the detailed description thereof is omitted.

FIG. 7 is a view showing an optical pick-up device including a spherical aberration compensation device according to a third embodiment of the present invention.

An optical pick-up apparatus 300 comprises a Blue-LD (blue laser diode) 310, a diffraction grating 315, a first half-wave plate 320, a beam splitter 325, a collimator lens 335, a reflex mirror 340, a spherical aberration compensator 350, an object lens 360, a sensor lens 365, and a photo detector 370.

Herein, since the functions of the Blue-LD 310, diffraction grating 315, beam splitter 315, collimator lens 335, reflex mirror 340, object lens 365 and photo detector 270 are similar to those of optical components shown in FIG. 1, a detailed description of these components is omitted.

The first half-wave plate 320 renders phases of laser beams separately received from the diffraction grating 315 to be preceded or delayed about 180°, thereby changing the direction of received polarized beams. That is, the first half-wave plate 320 transmits laser beams emitted from the diffraction grating 315 after converting them into P-polarized beams or S-polarized beams.

The spherical aberration compensator 350 is located between the reflex mirror 340 and the object lens 360 and compensates for the spherical aberrations of the laser beams, which are received by the optical disc 300a, and the laser beams, which are reflected from the optical disc 300a and reenter the photo detector 370.

The spherical aberration compensator 350 has a second half-wave plate 352, a liquid crystal panel (LCP) 354, and a quarter-wave plate 356.

The second quarter-wave plate 352 renders the phases of the laser beams polarized vertically or horizontally in the direction of the laser beams to be preceded or delayed about 180°, thereby changing the direction of incident polarized beams. That is, the second half-wave plate 352 transmits laser beams reflected from the reflex mirror 340 after converting them into P-polarized beams or S-polarized beams.

The liquid crystal panel 354 adjusts the phases of the laser beams, which are received by the optical disc 300a through the object lens 160, and laser beams, which are reflected by the optical disc 300a and reenter the liquid crystal panel 144, thereby compensating for the spherical aberrations of the laser beams. The liquid crystal panel 354 according to an embodiment of the present invention can conduct spherical aberration compensation for S-polarized beams.

The liquid crystal panel 354 comprises a plurality of transparent substrates opposing each other; a plurality of transparent electrodes formed on inner sides of the transparent substrates, respectively, electric power is applied to the transparent electrodes; and a liquid crystal layer formed between the transparent electrodes, the liquid crystal layer transmitting incident laser beams in different refractive indexes when electric voltage is applied to the transparent electrodes. The liquid crystal molecules formed in the liquid crystal layer are aligned horizontally or vertically to the surfaces of the transparent substrates. The molecules formed in the liquid crystal layer are rotated to a predetermined direction depending on whether electric voltage is applied to the electrodes or not, and the reacting degree between received laser beams and liquid crystal molecules is varied depending on the alignment of the rotated molecules.

The liquid crystal panel 354 adjusts the refractive index of the liquid crystal layer in such a manner that a phase of laser beams is varied depending on the alignment of crystal molecules changed by the electric voltage applied to the transparent electrodes. That is, the liquid crystal panel 354 adjusts the refractive index of the liquid crystal layer in such a manner that an inverse spherical aberration distribution is produced, which corresponds to a spherical aberration distribution of S-polarized beams entering the liquid crystal layer.

The quarter-wave plate 356 rotates the phase of parallel laser beams about 90°, which are polarized vertically or horizontally in the direction of the laser beams and enter the quarter-wave plate, whereby the laser beams are converted to left-circularly-polarized beams or right-circularly-polarized beams, and transmits the converted beams. That is, the S-polarized beams subjected to spherical aberration compensation by the liquid crystal panel 354 are converted into right-circularly-polarized beams by the quarter-wave plate 356 and then transmitted through the quarter-wave plate 356. The quarter-wave plate 356 converts left-circularly-polarized beams, which are reflected and reenter the quarter-wave plate 356 from the optical disc 300a, into S-polarized beams.

Accordingly, the laser beams received by the liquid crystal panel 354 according to an embodiment of the present invention enter the liquid crystal panel 354 after having been converted into S-polarized beams by the second half-wave plate 352 and the quarter-wave plate 356.

The right-circularly-polarized beams emitted from the quarter-wave plate 356 are collected by the object lens 360 and then enter the recording layer of the optical disc 300a. Further, the laser beams reflected and received from the optical disc 300a are collected by the sensor lens 365 and then enter the photo detector 370.

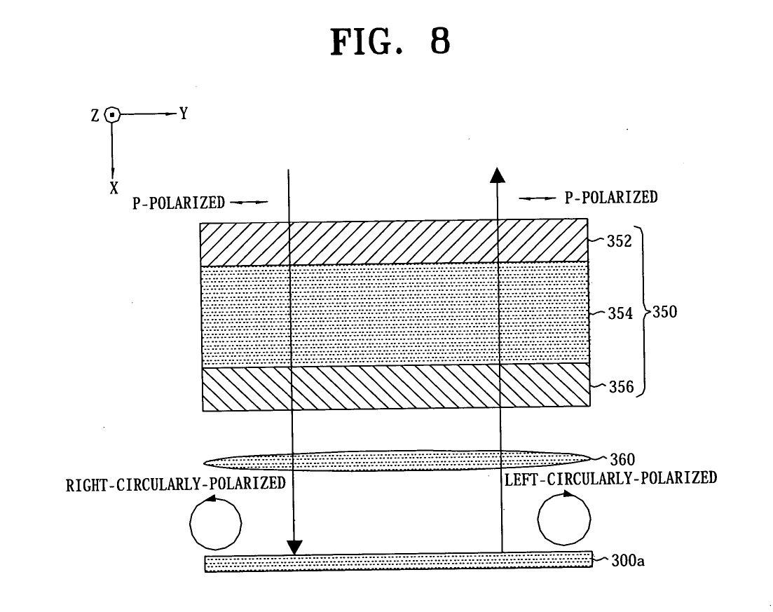

Hereinbelow, the operation of the spherical aberration compensator according to the another embodiment of the invention shown in FIG. 7 is described with reference to FIG. 8. In the present embodiment, the case in which P-polarized beams are incident into the spherical aberration device 350 is described by way of example.

FIG. 8 is a view illustrating the operation of the spherical aberration compensator shown in FIG. 7.

Referring to FIG. 8, the second half-wave plate 352 renders the phase of P-polarized beams received by the spherical aberration compensator 140 to be preceded about 180°, thereby converting the P-polarized beams into S-polarized beams. The beams converted into S-polarized beams by the second half-wave plate 352 are subjected to spherical aberration compensation by the liquid crystal panel 354. That is, the liquid crystal panel 354 adjusts the refractive index of the liquid crystal layer in such a manner that an inverse spherical aberration distribution is produced, which corresponds to a spherical aberration distribution of the S-polarized beams, which are received by the optical disc 300a. Accordingly, the S-polarized beams received by the liquid crystal panel 354 are subjected to spherical aberration compensation by the liquid crystal panel 144 and then enter the quarter-wave plate 356.

The S-polarized beams, which enter the quarter-wave plate 356 after having been subjected to spherical aberration compensation by the liquid crystal panel 354, are rotated about 90° by the quarter-wave plate 356, as a result of which the S-polarized beams are converted into right-circularly-polarized beams and then transmitted. The right-circularly polarized beams received from the quarter-wave plate 356 are received by the optical disc 300a. Thereby, a beam spot is formed on the recording surface of the optical disc 300a.

Meanwhile, the beam spot formed on the recording layer of the optical disc 300a is reflected by a pit formed on the optical disc 300a, and the reflected beams reenter the photo detector 370 through the object lens 360, spherical aberration compensator 350, reflex mirror 340, collimator lens 335, beam splitter 325, and sensor lens 365.

That is, the right-circularly-polarized beams received by the optical disc 300a are reflected by the optical disc 300a and then reenter the quarter-wave plate 356. At this time, the right-circularly-polarized beams received by the optical disc 300a are converted into left-circularly-polarized beams by being reflected by the optical disc 300a. The quarter-wave plate 356 converts the left-circularly-polarized beams incident from the optical disc 300a into S-polarized beams by delaying the phase of the left-circularly-polarized beams about 90°.

The liquid crystal panel 354 compensates the spherical aberration of the S-polarized beams, which are received from the quarter-wave plate 356, and then renders the compensated S-polarized beams to enter the second half-wave plate 352. The second half-wave plate 352 delays the phase of the S-polarized beams subjected to spherical aberration compensation by the liquid crystal panel 354 about 180°, whereby the S-polarized beams are converted into P-polarized beams and then transmitted. The laser beams incident from the second quarter-wave plate 352 enter the photo detector 370 through the reflex mirror 340, collimator lens 335, beam splitter 325 and sensor lens 365.

As described above, the optical pick-up apparatus 300 according to an embodiment of the present invention, it is possible to implement spherical aberration compensation for laser beams which are received by the optical disc 300a, and laser beams which are reflected from the optical disc 300a and then enter the photo detector 370.

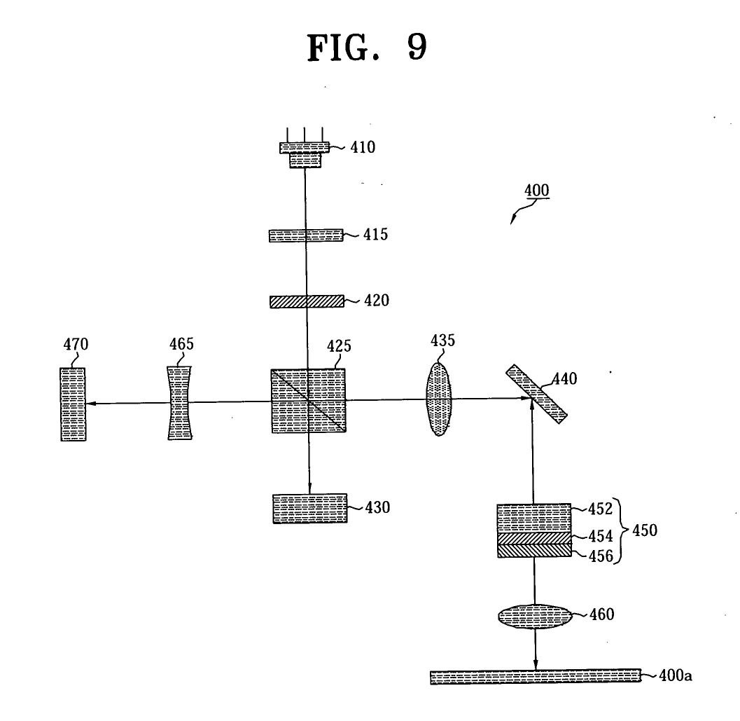

Meanwhile, FIG. 9 is a view showing an optical pick-up apparatus including a spherical aberration compensator according to another embodiment of the present invention.

Referring to FIG. 9, the optical pick-up apparatus 400 according to an embodiment of the present embodiment comprises a Blue-LD 410, a diffraction grating 435, a first half-wave plate 420, a beam splitter 425, a collimator lens 435, a reflex mirror 440, a spherical aberration compensator 450, an object lens 460, a sensor lens 465 and a photo detector 470.

In an embodiment of the present embodiment, the blue-LD 410, first half-wave plate 420, beam splitter 425, collimator lens 435, reflex mirror 440, object lens 460, and sensor lens 465, of which the functions are similar to those of the optical components shown in FIG. 1, are not described and only the spherical aberration compensator and its related parts are described.

The spherical aberration compensator 450 according to an embodiment of the present embodiment comprises a liquid crystal panel 452, a second half-wave plate 454, and a quarter-wave plate 456.

The liquid crystal panel 452 compensates for the spherical aberrations of laser beams which are received by an optical disc 400a through the object lens 460 and laser beams which are reflected from the optical disc 400a and then reenter the photo detector 470. The liquid crystal 452 according to an embodiment of the present embodiment can compensate for the spherical aberration of P-polarized beams. For example, the liquid crystal panel 452 compensates by adjusting the reflex index of the liquid crystal layer in such a manner that an inverse spherical aberration distribution is produced, which corresponds to the spherical aberration distribution of the P-polarized beams reflected from the reflex mirror 440 and the quarter-wave plate 456.

The second half-wave plate 454 converts the direction of received polarized laser beams by rendering the phase of the polarized laser beams to be preceded or delayed about 180°. In addition, the second half-wave plate 454 coverts the P-polarized beams, which are subjected to spherical aberration compensation and then enter the liquid crystal panel 452, into S-polarized beams by rendering the phase of the P-polarized beams to be preceded about 180°.

The quarter-wave plate 456 changes the direction of received polarized laser beams by rendering the phase of the polarized laser beams to be preceded or delayed about 90°. That is, the quarter-wave plate 456 converts the S-polarized beams, which are received from the second half-wave plate 456, into right-circularly-polarized beams by rendering the phase of the S-polarized beams about 90°. In addition, the quarter-wave plate 456 converts the left-circularly-polarized beams, which are reflected and reenter the quarter-wave plate 456 from the optical disc 400a, into S-polarized beams by delaying the left-circularly-polarized beams about 90°.

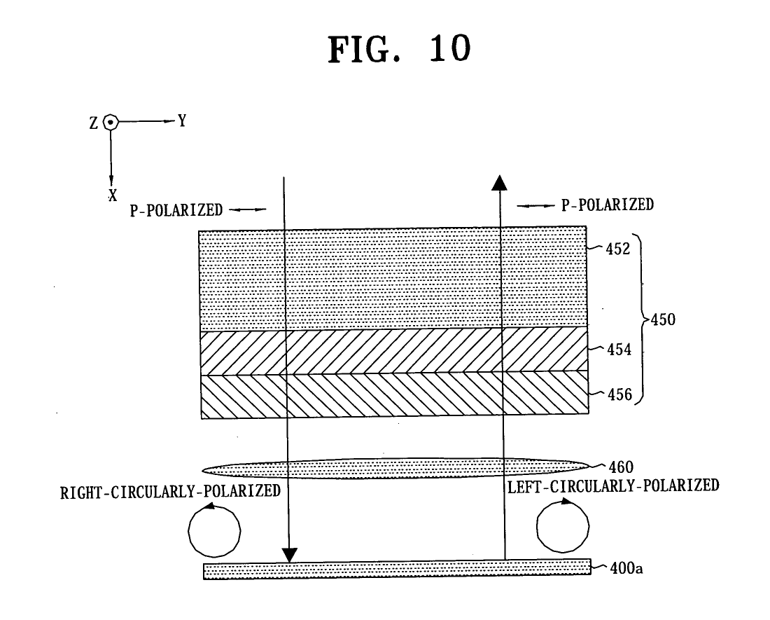

Hereinbelow, the operation of the spherical aberration compensator according to the fourth embodiment shown in FIG. 9 is described with reference to FIG. 10. In this embodiment, the case in which P-polarized beams enter the spherical aberration device 450 is described.

Referring to FIG. 10, the liquid crystal panel 452 adjusts the reflective index of the liquid crystal layer in such a manner that an inverse spherical aberration distribution is produced, which corresponds to the spherical aberration distribution of the P-polarized beams which are received by an optical disc 400a. Thereby, the P-polarized beams received by the liquid crystal panel 452 enter the second half-wave plate 454 after the spherical aberration thereof is compensated for by the liquid crystal panel 452. The second half-wave plate 454 rotates the phase of the P-polarized beams received by the second half-wave plate 454 about 180°, thus converting the P-polarized beams into S-polarized beams.

Then, the quarter-wave plate 456 converts the S-polarized beams received from the second half-wave plate 454 into right-circularly-polarized beams by rendering the phase of the S-polarized beams to be preceded about 90°. The right-circularly-polarized beams emitted from the quarter-wave plate 456 are received by and collected by the object lens 460 and then received by the optical disc 400a. Thereby, a beam spot is formed on a recording surface of the optical disc 400a.

In addition, the right-circularly-polarized beams received by the optical disc 400a are reflected by the optical disc 400a and then reenter the quarter-wave plate 456. At this time, the right-circularly-polarized beams received by the optical disc 400a are converted into left-circularly-polarized beams by being reflected by the optical disc 400a. The quarter-wave plate 456 converts the left-circularly-polarized beams, which are incident from the optical disc 400a, into S-polarized beams by delaying the phase of the left-circularly-polarized beams about 90°.

Then, the second half-wave plate 454 converts the S-polarized beams, which are received from the quarter-wave plate 456, into P-polarized beams and then transmits the P-polarized beams into the liquid crystal panel 452. The P-polarized beams received from the second half-wave plate 454 are subjected to spherical aberration compensation by the liquid crystal panel 452 and then enter the photo detector 470 through the reflex mirror 440, collimator lens 435, beam splitter 425 and sensor lens 465.

As describe above, according to the optical pick-up apparatus 400 of the fourth embodiment, it is possible to compensate for spherical aberrations of both the laser beams which are received by an optical disc 400a, and the laser beams which are reflected from the optical disc 400a and then enter the photo detector 470.

Although the Blue-LD, diffraction grating, FPD and photo detector are described and shown as being individually and separately constructed, the embodiments of the present invention are not limited to this configuration. It is possible to form Blue-LD, diffraction grating, FPD, photo detector and holographic element as a single package using a holographic element. Where the Blue-LD, diffraction grating, FPD, photo detector and holographic element are formed as a single package, there will be advantages in that it is possible to simplify the construction of the optical pick-up apparatus, and in particular, such a package can be usefully employed when optical power emitted from a light source is small.

As described above, according to embodiments of the present invention, it is possible to improve the recording and reproducing capability of the optical pick-up apparatus by compensating for spherical aberrations produced due to differences in thicknesses in the optical recording medium, refractive index, numerical aperture of an object lens, etc. in the process of laser beams being emitted from a light source are received by an optical recording medium and that the laser beams received by the optical recording medium are reflected.

In particular, because the spherical aberration of the laser beams, which are reflected by an optical disc and enter a photo detector, is compensated for, it is possible to avoid a problems that information is recorded on an incorrect track or data already recorded on a neighbor track is erased because it is difficult to control a tracking servo due to interference between adjacent signals. In addition, it is possible to enhance reproducing capability by preventing focus offset caused by failing to precisely align a focusing position at the time of recording data on an optical disc.

While the embodiments of the present invention have been shown and described with reference to the representative embodiments thereof in order to exemplify the principle of the present invention, the present invention is not limited to the embodiments shown and described. It should be understood that various modifications and changes can be made by those skilled in the art without departing from the spirit and scope of the invention as defined by the appended claims. Therefore, it should be appreciated that such modifications, changes and equivalents thereof are all included within the scope of the present invention.

1. A spherical aberration compensator for an optical pick-up for recording or reproducing information into or from an optical recording medium by illuminating predetermined laser beams, wherein the spherical aberration compensator comprises:
a wave plate for converting first parallel beams, which are polarized in one of vertical and horizontal directions and enter the wave plate, into first circularly-polarized beams to be received by the optical recording medium, and converting second circularly-polarized beams, which are reflected by the optical recording medium and reenter the wave plate, into second parallel beams which are vertical to the first parallel beams; and
a liquid crystal plate provided between the wave plate and the optical recording medium for adjusting the phases of the first circularly-polarized beams and the second circularly-polarized beams.

2. The spherical aberration compensator according to claim 1, wherein the wave plate comprises a quarter-wave plate, which rotates the phase of received beams about 90° to convert the phase.

3. The spherical aberration compensator according to claim 1, wherein the liquid crystal panel comprises:
a plurality of transparent substrates opposing each other;
a plurality of transparent electrodes provided on the inner sides of the substrates, respectively, and applying electric power to the transparent electrodes; and
a liquid crystal layer formed from liquid crystal molecules aligned in a predetermined direction and angle in relation to the surfaces of the transparent electrodes, the liquid crystal layer transmitting received beams with different refractive indexes depending on polarized directions of the beams.

4. The spherical aberration compensator according to claim 3, wherein the predetermined angle comprises substantially 45°.

5. A spherical aberration compensator for an optical pick-up for recording and reproducing information into or from an optical recording medium by illuminating predetermined laser beams, wherein the spherical aberration compensator comprises:
a wave plate for converting first parallel beams, which are polarized in one of vertical and horizontal directions and enter the wave plate into second parallel beams, thus rendering the second parallel beams to be received by the optical recording medium, and converting the second parallel beams, which are reflected by the optical recording medium and reenter the wave plate, into the first parallel beams, the second parallel beams being vertical to the first parallel beams; and
a liquid crystal panel provided in front of the wave plate for adjusting the phases of the first parallel beams, which are received by the optical recording medium, and the second parallel beams, which are reflected from the optical recording medium and reenter the wave plate.

6. The spherical aberration compensator according to claim 5, wherein the wave plate comprises a half-wave plate, which rotates the phase of incident beams about 180°, to convert the phase.

7. The spherical aberration compensator according to claim 5, wherein the liquid crystal panel comprises:
a plurality of transparent substrates opposing each other;
a plurality of transparent electrodes provided on the inner sides of the substrates, respectively, and applying electric power to the transparent electrodes; and
a liquid crystal layer formed from liquid crystal molecules aligned in one of vertical and horizontal directions in relation to the surfaces of the transparent electrodes, the liquid crystal layer transmitting received beams in different refractive indexes depending on polarized directions of the beams.

8. A spherical aberration compensator for an optical pick-up for recording and reproducing information into or from an optical recording medium by illuminating predetermined laser beams, wherein the spherical aberration compensator comprises:
a first wave plate for transmitting first parallel beams which are polarized in one of vertical and horizontal directions and enter the wave plate, after converting the first parallel beams into second parallel beams beams;
a second wave plate for converting the second parallel beams, which are received from the first wave plate, into first circularly-polarized beams, thus rendering the first circularly-polarized beams to enter the optical recording medium, and converting second circularly-polarized beams, which are reflected and received again from the optical recording medium, into the first parallel beams, thus transmitting the first parallel beams; and
a liquid crystal panel provided between the first and second wave plates for adjusting the phase of the second parallel beams incident from the first and second wave plates, thus compensating for spherical aberration.

9. The spherical aberration compensator according to claim 8, wherein the first parallel beams are P-polarized beams, which are polarized horizontally to and received by the optical recording medium, and the second parallel beams are S-polarized beams which are vertical to the first parallel beams.

10. The spherical aberration compensator according to claim 8, wherein the first wave plate comprises a half-wave plate which rotates the phase of beams received by the plate about 180° to convert the phase, and the second wave plate comprises a quarter-wave plate which rotates the phase of beams received into the plate about 90° to convert the phase.

11. The spherical aberration compensator according to claim 8, wherein the liquid crystal panel comprises:
a plurality of transparent substrates opposing each other;
a plurality of transparent electrodes provided on the inner sides of the transparent substrates, respectively, and applying electric power to the transparent electrodes; and
a liquid crystal layer formed from liquid crystal molecules aligned in one of vertical and horizontal directions in relation to the surfaces of the transparent electrodes, the liquid crystal layer compensating for the spherical aberration by adjusting the phase of the received second parallel beams when the electric power is applied to the transparent electrodes.

12. A spherical aberration compensator for an optical pick-up for recording and reproducing information into or from an optical recording medium by illuminating predetermined laser beams, wherein the spherical aberration compensator comprises:
a liquid crystal panel for compensating for the phase of first parallel beams, which are received by the optical recording medium, and the phase of the second parallel beams which are reflected by the optical recording medium after entering the recording medium and then reentering the liquid crystal panel;
a first wave plate provided between the liquid crystal panel and the optical recording medium for converting the first parallel beams, which are emitted from the liquid crystal panel, into second parallel beams, thus transmitting the second parallel beams; and
a second wave plate provided between the first wave plate and the optical recording medium for converting the second parallel beams, which are received from the first wave plate, into first circularly-polarized beams, thus rendering the first circularly-polarized beams to enter the optical recording medium, and converting second circularly-polarized beams, which are reflected and received again from the optical recording medium, into the first parallel beams, thus transmitting the first parallel beams to the first wave plate, and
wherein the first wave plate converts the second parallel beams, which are incident from the second plate, into the second parallel beams, thus transmitting the second parallel beams to the liquid crystal panel.

13. The spherical aberration compensator according to claim 12, wherein the first parallel beams comprise P-polarized beams, which are received after being polarized horizontally to the optical recording medium, and the second parallel beams comprise S-polarized beams which are vertical to the first parallel beams.

14. The spherical aberration compensator according to claim 12, wherein the first wave plate comprises a half-wave plate, which rotates the phase of beams entering the plate about 180° to convert the phase, and the second wave plate comprises a quarter-wave plate, which rotates the phase of beams entering the plate about 90° to convert the phase.

15. The spherical aberration compensator according to claim 8, wherein the liquid crystal panel comprises:
a plurality of transparent substrates opposing each other;
a plurality of transparent electrodes provided on the inner sides of the transparent substrates, respectively, electric power being applied to the transparent electrodes; and
a liquid crystal layer formed from liquid crystal molecules aligned in one of vertical and horizontal directions in relation to the surfaces of the transparent electrodes, the liquid crystal layer compensating for the spherical aberration by adjusting the phase of the first parallel beams entering the liquid crystal panel when the electric power is applied to the transparent electrodes.

16. A method providing an optical pick-up for recording or reproducing information into or from an optical recording medium by illuminating predetermined laser beams, the method comprising:
converting first parallel beams, which are polarized in one of vertical and horizontal directions and enter a wave plate, into first circularly- polarized beams to be received by the optical recording medium, and converting second circularly-polarized beams, which are reflected by the optical recording medium and reenter the wave plate, into second parallel beams which are vertical to the first parallel beams; and
providing a liquid crystal plate between the wave plate and the optical recording medium for adjusting the phases of the first circularly-polarized beams and the second circularly-polarized beams.

17. The method according to claim 16, wherein the wave plate comprises a quarter-wave plate, which rotates the phase of received beams about 90° to convert the phase.

18. The method according to claim 16, wherein the method further comprises:
providing a plurality of transparent substrates that oppose each other;
providing a plurality of transparent electrodes on the inner sides of the substrates, respectively, and applying electric power to the transparent electrodes; and
forming a liquid crystal layer from liquid crystal molecules aligned in a predetermined direction and angle in relation to the surfaces of the transparent electrodes, the liquid crystal layer transmitting received beams with different refractive indexes depending on polarized directions of the beams.

19. The method according to claim 18, wherein the predetermined angle comprises substantially 45°.
